(19) United States
(12) Patent Application Publication
(10) Pub. No.: US 2015/0032388 A1
(43) Pub. Date: Jan. 29, 2015

(54) METHOD OF CONTROLLING TRANSMISSION APPARATUS, TRANSMISSION APPARATUS, AND RECORDING MEDIUM

(71) Applicant: FUJITSU LIMITED, Kawasaki-shi (JP)

(72) Inventor: Shuichi Nakagawa, Kawasaki (JP)

(21) Appl. No.: 14/306,687

(22) Filed: Jun. 17, 2014

(30) Foreign Application Priority Data
Jul. 25, 2013 (JP) 2013-154817

(51) Int. Cl. G07C 3/02

(52) U.S. Cl. CPC G07C 3/02
USPC 702/34

(57) ABSTRACT

A method of controlling a transmission apparatus, executed by a processor, the transmission apparatus including a plurality of ports capable of connection to an optical module, the method includes receiving operating time information of the optical module, and monitor information including at least one of information on temperature of the optical module, optical output power, and a bias current value of a semiconductor laser at predetermined time intervals, when the optical module is coupled to a first port; calculating a deterioration point based on the operating time information and the monitor information at the predetermined time intervals; calculating an accumulated deterioration point by adding the deterioration point at the predetermined time intervals; and determining a deterioration degree of the optical module based on the accumulated deterioration point, when the optical module is recoupled to the first port, or when the optical module is coupled to a second port.

### CROSS-REFERENCE TO RELATED APPLICATIONS

This application is based upon and claims the benefit of priority from the prior Japanese Patent Application No. 2013-154817 filed on Jul. 25, 2013, the entire contents of which are incorporated herein by reference.

### FIELD

The embodiments discussed herein are related to a method of controlling a transmission apparatus, a transmission apparatus, and a recording medium.

### BACKGROUND

It is known that a transmission apparatus is provided which includes a plurality of ports capable of mounting optical modules, respectively, and which provides communication services in a state where the optical modules are mounted. For example, Japanese Laid-open Patent Publication No. 2003-8136 has disclosed a technique in which the differences between a temperature of a semiconductor laser and a target value are measured, and deterioration of the semiconductor laser is predicted based on the accumulated value of the differences.

However, even if an optical module is replaced, when the optical module has already been used for the other one of the ports, deterioration of the optical module on the port has proceeded for the amount corresponding to the used time. That is to say, a change in deterioration speed in accordance with the use time has not been taken into consideration.

### SUMMARY

According to an aspect of the invention, a method of controlling a transmission apparatus, executed by a processor, the transmission apparatus including a plurality of ports capable of connection to an optical module, the method includes receiving operating time information indicating information of operating time of the optical module, and monitor information including at least one of information on temperature of the optical module, optical output power of the optical module, and a bias current value of a semiconductor laser disposed in the optical module at predetermined time intervals, when the optical module is coupled to a first port among the plurality of ports; calculating a deterioration point indicating a deterioration degree of the optical module based on the operating time information and the monitor information at the predetermined time intervals; calculating an accumulated deterioration point by adding the deterioration point calculated at the predetermined time intervals; and determining a deterioration degree of the optical module based on the accumulated deterioration point, when the optical module is recoupled to the first port, or when the optical module is coupled to a second port different from the first port among the plurality of ports.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating an example of a transmission apparatus according to an embodiment;

FIG. 1B, FIG. 1C, and FIG. 1D are diagrams illustrating an example of an LIU part;

FIG. 2 is a block diagram illustrating an overall configuration of the transmission apparatus;

FIG. 3 is a diagram illustrating an example of deterioration additional points;

FIG. 4 is a diagram illustrating an example of an operation information collection table;

FIG. 5 is a diagram illustrating an example of an operation information collection table;

FIG. 6 is a diagram illustrating an example of an operation information collection table;

FIG. 7 is a diagram illustrating a relationship between accumulated operating time and deterioration point accumulated value;

FIG. 8 is a diagram illustrating a relationship between accumulated operating time and deterioration point accumulated value;

FIG. 9 is a diagram illustrating a relationship between accumulated operating time and deterioration point accumulated value;

FIG. 10 is a diagram illustrating an example of a flowchart of processing that is executed at the time of updating the operation information collection table;

FIG. 11 is an example of a flowchart illustrating details of operation information collection and update of the operation information collection table from when deterioration monitoring of an optical pluggable module is started;

FIG. 12 is an example of a flowchart illustrating details of operation information collection and update of the operation information collection table from when deterioration monitoring of an optical pluggable module is started; and

FIG. 13 is a block diagram for explaining a hardware configuration for achieving each unit by a program.

### DESCRIPTION OF EMBODIMENTS

In the following, a description will be given of embodiments with reference to the drawings.

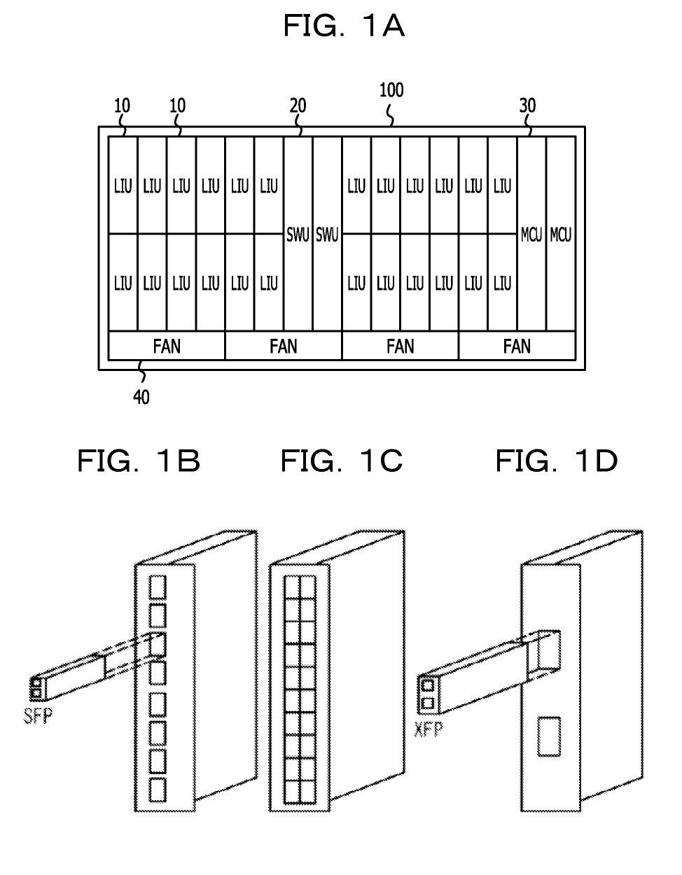

FIG. 1A is a diagram illustrating an example of a transmission apparatus 100 according to an embodiment. Referring to FIG. 1A, the transmission apparatus 100 includes an LIU unit 10, a SWU unit 20, a MCU unit 30, a FAN unit 40, and the like. The LIU unit 10 is a line interface unit, and is mounted in a slot of the transmission apparatus 100. The LIU unit 10 includes a port to which an optical pluggable module is mounted, and provides a service in accordance with an optical pluggable module to be mounted. A plurality of LIU units 10 may be disposed in accordance with support functions of services to be provided. The SWU unit 20 is a switch control unit, and outputs a signal from each LIU unit 10, or a signal to each LIU unit 10 in a switching manner. The MCU unit 30 is a main control unit, and performs operation monitoring of the optical pluggable module, and the like. The FAN unit 40 includes a cooling fan, and cools the LIU unit 10, the SWU unit 20, the MCU unit 30, and the like.

For the LIU unit 10, it is possible to use various kinds of units. FIG. 1B illustrates an SONET/SDH service: 8-port SFP, which is an example of the LIU unit 10. FIG. 1C illustrates an Ethernet (registered trademark) packet service: 20-port small form factor pluggable (SFP), which is an example of the LIU unit 10. FIG. 1D illustrates 10-G transponder service: 2-port 10-gigabit small form factor pluggable (XFP) or 10-G Ether service: 2-port XFP, which is an example of the LIU unit 10. SFP and XFP are examples of the optical pluggable modules. SFP and XFP have a configuration in accordance with the multi-source agreement (MSA) standard.

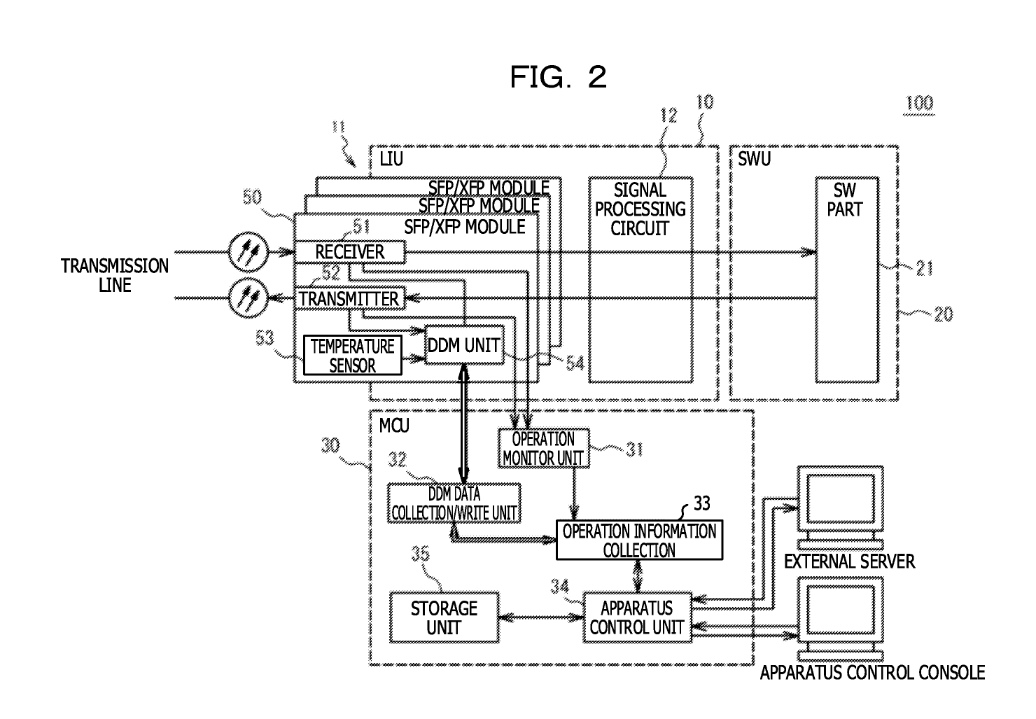

FIG. 2 is a block diagram illustrating an overall configuration of the transmission apparatus 100. Referring to FIG. 2, the LIU unit 10 includes a plurality of ports 11, to which optical pluggable modules 50 are mounted, respectively, a signal processing circuit 12, and the like. In the example in FIG. 2, a plurality of optical pluggable modules 50 are mounted to the ports 11, respectively. The SWU unit 20 includes a switch unit 21, and the like. The MCU unit 30 includes an operation monitoring unit 31, a DDM data collection/write unit 32, an operation information collection unit 33, an apparatus control unit 34, a storage unit 35, and the like. The optical pluggable module 50 is detachable from the port 11, and is an optical module including a memory, and an optical element. The optical pluggable module 50 includes a receiver 51, a transmitter 52, a temperature sensor 53, a DDM unit 54, and the like, for example.

The receiver 51 performs photoelectric conversion on an optical signal input from a transmission line by a light receiving element into an electronic signal, and transmits the obtained electronic signal to the signal processing circuit 12. The signal processing circuit 12 performs predetermined processing on the received signal, and transmits the signal to the switch unit 21. On the other hand, the signal processing circuit 12 performs predetermined signal processing on the signal from the switch unit 21, and transmits the signal to the transmitter 52. The transmitter 52 includes a light emitting element, such as a semiconductor laser, or the like, converts the received electronic signal into an optical signal, and transmits the optical signal to the outside through a transmission line. The temperature sensor 53 detects ambient temperature of the optical pluggable module 50.

The DDM unit 54 performs self-diagnosis using a digital diagnostic monitoring (DDM) function, and stores monitor information of the optical pluggable module 50. The monitor information of the optical pluggable module 50 includes detection temperature of the temperature sensor 53, optical output power of the transmitter 52, a bias current value of the transmitter 52, and the like. The DDM unit 54 has a user rewritable area, and stores the operating time (the accumulated value) of the optical pluggable module 50, and the accumulated value of the deterioration point in that area. The DDM unit 54 may store individual information of the optical pluggable module 50. A detailed description will be given later of the operating time, the deterioration point accumulated value, and the individual information.

Here, a description will be given of a deterioration mode of the optical pluggable module 50. The optical pluggable module 50 has a self-diagnosis function. Thus, if a peripheral circuit of a light emitting element of the transmitter 52, or the like fails, the optical pluggable module 50 automatically shuts down. In this case, it is difficult to escape from the occurrence of an incidence in which the normal optical communication becomes incapable, the signal stops, and the service becomes unavailable at least temporarily. Further, the occurrence of a shutdown is unpredictable. Accordingly, it is desirable to predict a failure time and a replacement time before the failure actually occurs.

The deterioration modes up to the occurrence of a failure of the light emitting element of the optical pluggable module 50 include a rapid deterioration mode having an indication of a sudden increase in the operating current, an indication of a sudden decrease in the optical output, or the like. The deterioration modes also include a slow deterioration mode, which is natural aging deterioration of the light emitting element, having a gradual increase in the individual operating currents, or a gradual decrease in the optical output without a sudden deterioration indication. The deterioration modes also include a “sudden death” mode in which a sudden deterioration occurs even though normal operation continues for a certain period of time.

For the factors for deterioration modes, such as described above, it is difficult to disregard the influence, such as a use state of the transmission apparatus 100, for example an operation mode of the transmission apparatus 100, an environmental condition, an operation time, etc., and ambient temperature affected by the transmission apparatus 100, and the like. To put it another way, a life of each of the optical pluggable modules 50 is different for each module depending on the influence of an environment, a use mode, etc., such as an apparatus to which the module is mounted, an operation condition, and the like. Accordingly, it is difficult to determine a replacement time of the optical pluggable module 50, or to correctly predict a failure thereof.

As a mechanism for automatically predicting a failure of a light emitting element, it is thought that there is a method of predicting a failure by collecting the difference value of currents for a failure detection, and detecting a sudden deterioration indication at a change point in time from the previous measurement value. However, it is difficult to predict a failure time unless there are any indications of a failure. Further, there is a problem in that it is difficult to detect a tendency of gradual deterioration, such as aging deterioration, and the like.

The optical pluggable module 50 has convenience that allows easy replacement. Thus, in the transmission apparatus 100, there are cases where the optical pluggable module 50 in use is replaced, and cases where the optical pluggable module 50 that was used in the past is re-used. In this case, there is no information on the state of the aging deterioration of the optical pluggable module 50 that has been remounted, which had been influenced by the operational environment, and the use mode up to that time, and the like. Accordingly, it is difficult to determine a failure time in consideration of aging deterioration by the method of predicting a failure time using a change from a state at restart time. On the other hand, the transmission apparatus 100 according to the present embodiment includes a configuration that allows prediction of the degree of deterioration causing a failure of the optical pluggable module 50 with high precision.

The operation monitoring unit 31 monitors a state signal sent to the outside from the optical pluggable module 50 so as to monitor the state (an alarm, a failure, and the like) of the optical pluggable module 50. The operation monitoring unit 31 obtains the mount location information of the optical pluggable module 50, and transmits the information to the operation information collection unit 33. The DDM data collection/write unit 32 collects the individual information, the operating time (the accumulated value), the monitor information, and the like from each of the optical pluggable modules 50, and transmits the information to the operation information collection unit 33. In the present embodiment, the monitor information is detection temperature of the temperature sensor 53, the optical output power of the transmitter 52, and a bias current value of the transmitter 52, for example. The apparatus control unit 34 stores the information collected by the operation information collection unit 33 into the storage unit 35. The apparatus control unit 34 calculates a deterioration point from the operating time, and the monitor information, and stores the calculated deterioration point, and the accumulated value thereof into the storage unit 35. The deterioration point is a deterioration degree of the optical pluggable module 50, which is represented by a numeric value.

The MCU unit 30 is connected to an apparatus control console, and may have a function of extracting collected operation information, and transferring the information to an external server apparatus in accordance with operation from the console.

Here, a description will be given of accumulation of the deterioration points. The apparatus control unit 34 may give a deterioration point when operating time of the optical pluggable module 50 exceeds a predetermined time period. For example, when 24 hours have passed for the operating time, deterioration point is counted as “1”. In this case, “1” is added to the deterioration point accumulated value every 24 hours of the operating time.

The apparatus control unit 34 may give a deterioration point if the average value of the detection temperature by the temperature sensor 53 for a certain time period is out of a reference range. For example, if the average value of the detection temperature by the temperature sensor 53 for 24 hours is out of a reference range, the deterioration point is calculated as “1”. In this case, every time the average value continues to be out of the reference range for each 24 hours, “1” is added to the deterioration point accumulated value. For an optical output power of the transmitter 52, and a bias current value of the transmitter 52, the deterioration point is increased in the same manner.

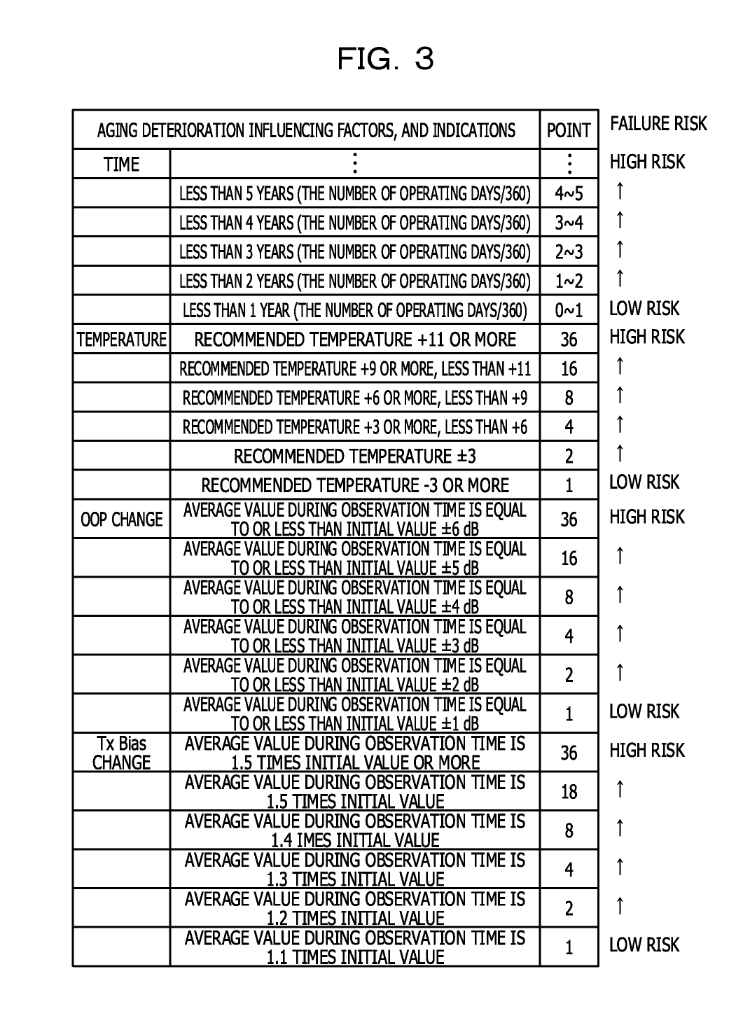

The apparatus control unit 34 may weight the deterioration point so as to increase the deterioration point as the failure risk increases. The apparatus control unit 34 may use the weighted value (hereinafter referred to as a deterioration additional point) as a deterioration point. In the following example, a description will be given of the example of using the deterioration additional point as a deterioration point. Here, a description will be given of an example of the deterioration additional point with reference to FIG. 3. As an example, a description will be given of a deterioration additional point based on the operating time, the deterioration additional point based on temperature condition, the deterioration additional point based on the optical output power, and the deterioration additional point based on the bias change.

A state of aging deterioration of the optical pluggable module 50 is expressed numerically in a virtual manner with passage of time when the optical pluggable module 50 is mounted on the port 11, and then is in operation. And an increase in the continuous operating time is regarded as a deterioration additional point. A simple accumulation of the operating time is not employed. The weighting is carried out such that the longer the operating time becomes, the more the tendency of deterioration increases during a time period from the initial operating time (BL) to the time of life expiration (EL), and thus the more a failure risk increases. And a numeric value calculated by the number of operating days/360 is accumulated as a deterioration point.

In general, it is thought that a life of a semiconductor laser decreases to ½ with respect to a temperature increase by 10° C. in the vicinity of room temperature from a relational expression between an increase rate in the temperature and an operating current. Thus, weighting is carried out such that the greater the difference between ambient temperature during observation time and the recommended operating temperature (the ambient temperature at the time of calculating a failure case by an average use), the higher the failure risk becomes, and the result is accumulated as a deterioration point.

In monitoring the value of the optical output power of the optical pluggable module 50 at initial operating time, with respect to a change of an increase and a decrease in the output power at initial operating time, output fluctuations (an increase and a decrease of power) and the low state of the output power are observed. The deterioration points are accumulated with weighting such that the stronger the tendency of change, the higher the failure risk becomes.

A semiconductor laser has an aging deterioration tendency, in which a drive current increases in automatic power control (APC) for maintaining the optical output at a certain value. Thus, in consideration of a degree of influence to the system, it is thought that the life has expired when the bias current of the transmitter 52 becomes 1.5 times the initial value. The deterioration points are accumulated by weighting such that the nearer to 1.5 times the initial value, the higher the failure risk becomes.

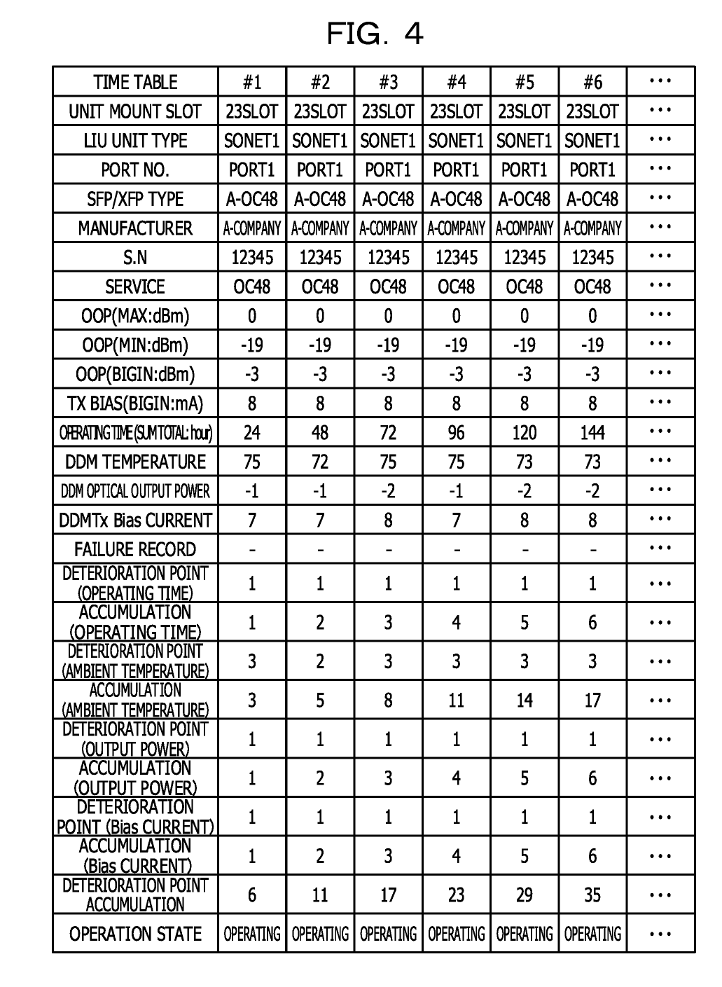

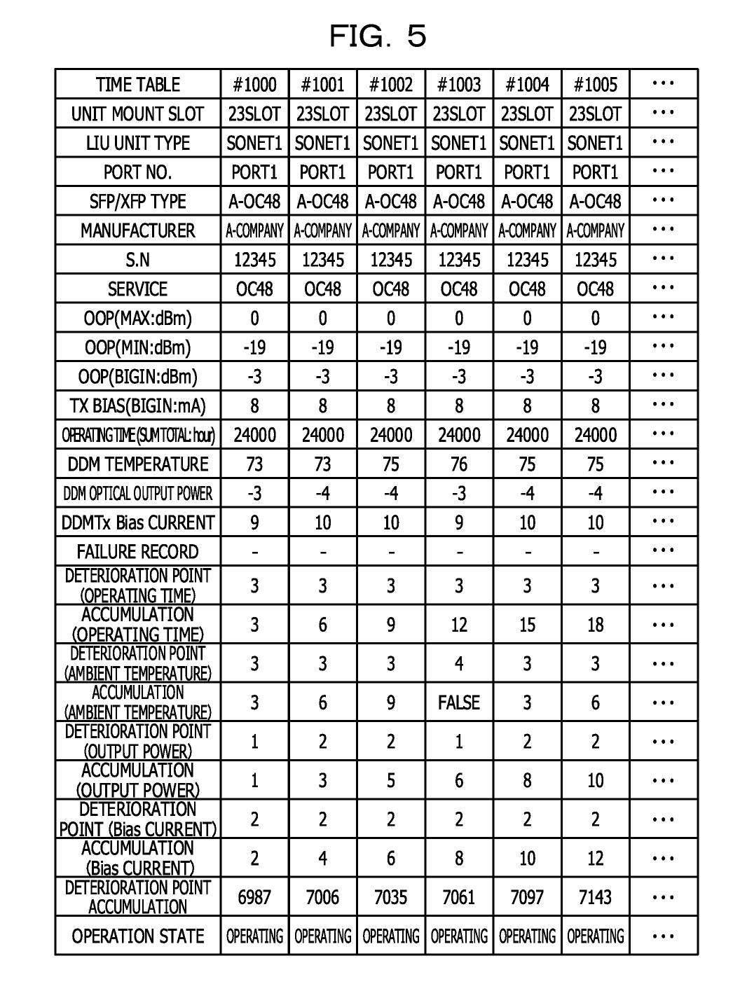

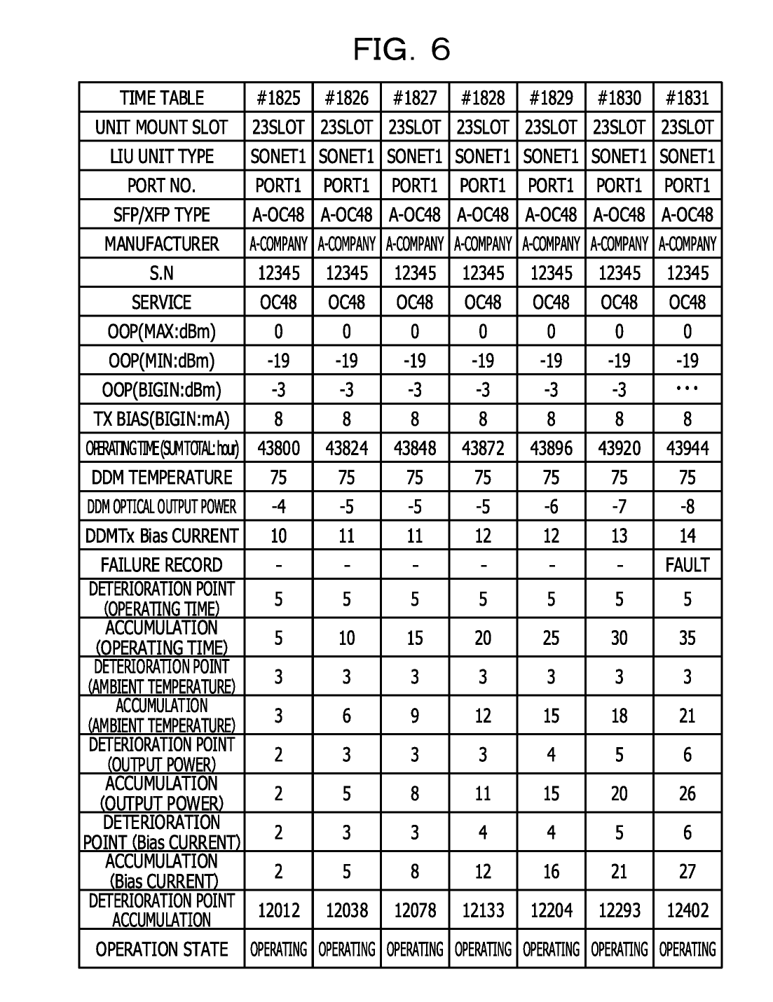

FIG. 4 to FIG. 6 are diagrams illustrating examples of tables of data stored in the storage unit 35, respectively (hereinafter, referred to as operation information collection tables). The examples in FIG. 4 to FIG. 6 illustrate the operation information collection tables of any one of optical pluggable modules 50. An operation information collection table is created in accordance with passage of time at predetermined time intervals (for example, one hour, one day, or one week). In the example in FIG. 4, a time table including six times of data from #1 to #6 is illustrated. In the example in FIG. 5, a time table including six times of data from #1000 to #1005 is illustrated. In the example in FIG. 6, a time table including seven times of data from #1825 to #1831 is illustrated.

The operation information collection table includes mount location information. The mount location information includes a unit mount slot, an LIU unit type, and a port number. The unit mount slot is a slot position (number) to which the LIU unit 10 including the mounted target optical pluggable module 50, is mounted in the transmission apparatus 100. The LIU unit type is a type of the LIU unit 10. The port number is a port number to which the target optical pluggable module 50 is mounted in the LIU unit 10. The individual information includes a functional type (SFP/XFP type) of the target optical pluggable module 50, a manufacturer, a serial number (S.N.), an operating service, a specification value (a maximum value, a minimum value, and an initial value of output power (OOP value)), a typical value of the bias current of the transmitter 52, and the like.

The operation information collection table includes operating time. The operating time is an accumulated used time of the optical pluggable module 50. The operating time may be elapsed time from when the optical pluggable module 50 is mounted to the port 11, or operation time after the optical pluggable module 50 is started in a state of being mounted to the port 11. The operation information collection table includes monitor information of the DDM unit 54. The monitor information includes a detection value (DDM temperature) of the temperature sensor 53, the optical output power of the transmitter 52 (DDM optical output power), the bias current value (DDMTx bias current) of the semiconductor laser of the transmitter 52, and a failure record. The operation information collection table includes a deterioration point, a deterioration point accumulated value, and an operating state.

The DDM data collection/write unit 32 writes the deterioration point accumulated value, and the operating time (the accumulated value) into the user rewritable area of the DDM unit 54 of the target optical pluggable module 50 at the time of updating the operation information collection table. Thereby, even if each of the pluggable modules 50 is unplugged from the port 11, the operating time (the accumulated value) and the deterioration point accumulated value of the module itself are maintained.

Next, a description will be given of a mechanism for prompting a maintenance personnel to carry out normality test, and to be aware of the importance of early replacement by predicting a deterioration degree of the optical pluggable module 50 based on the deterioration point accumulated value. Because of the characteristic of the optical pluggable module 50, aging deterioration proceeds even if the optical pluggable module 50 is used on the recommended environmental condition. Thus, the apparatus control unit 34 numerically express a situation in which the deterioration state is increased in accordance with the passage of time as a deterioration point, and the deterioration point is added to the deterioration point accumulated value.

In the calculation of the deterioration additional point described in FIG. 3, it is possible to calculate the deterioration additional point that is stored for a certain time period in a state in which there is no significant deterioration indication by storage of the accumulated points of the elapsed time, the recommended operating temperature condition, and the minimum deterioration condition. It is possible to calculate the assumption condition for use as an aging deterioration model by changing the addition conditions of the deterioration additional points, and performing simulation, and thus it is possible to change the assumption condition to meet the environmental condition and the risk condition requested by a customer.

For example, by continuous operation for 20 years, the deterioration point accumulated value becomes 100810 points on the condition that there is no significant deterioration. With reference to the deterioration point accumulated value, it is determined that a state having 100000 points is a sate in which the failure occurrence risk of the optical module has an increased aging deterioration, and is set to the upper limit value.

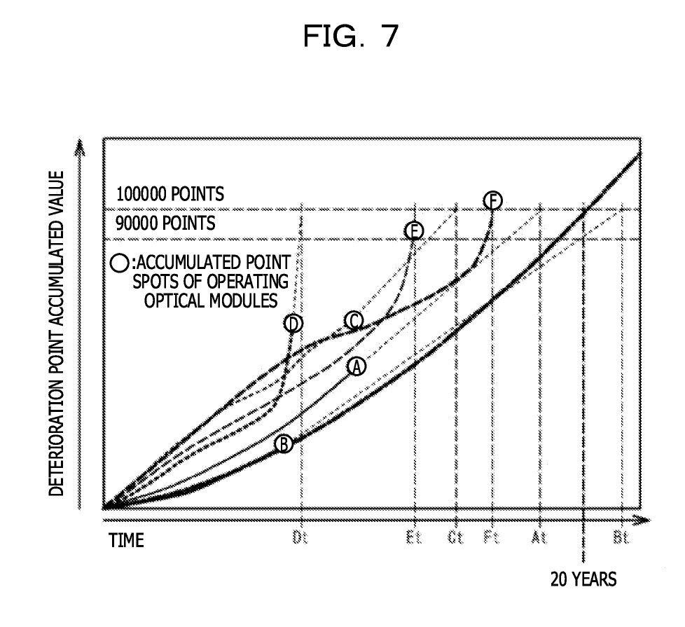

FIG. 7 is a diagram illustrating a relationship (monitoring example 1) between the operating time (the accumulated value), and the deterioration point accumulated value. Referring to FIG. 7, a bold dash-single-dot line represents the deterioration point accumulated value (aging deterioration model) on the assumption condition. In the example in FIG. 7, the upper limit value indicating a state having an increased failure occurrence risk by aging deterioration is set to 100000 points. An intermediate area indicating one stage before an increased state of the failure occurrence risk by aging deterioration is set to 90000 to 100000 points.

The points A to F encircled by O indicate deterioration point accumulated values of the individual optical pluggable modules 50 at the point in time of passage of operating time. A and B indicate a state in which even though there is a difference between operating time, both points increase substantially in the same manner as the accumulated value of the aging deterioration model, and there is no abrupt deterioration indication. Estimated increases of A and B from the current point in time to accumulated deterioration points having an increasing failure risk are represented by approximate straight lines. And At and Bt, which are time at which the approximate straight lines intersect the upper limit value, are derived, and thus it is possible to use these for predicting replacement time at the present time.

C has a tendency in which although there is no abrupt increase caused by the deterioration indication, the increasing rate of the deterioration point is higher than that of A, which has the same operating time. Accordingly, although there is no failure indication at this point in time, it is estimated that the estimate time Ct when the approximate straight line reaches the upper limit value is earlier than At and Bt. D is a case where a same deterioration point accumulated value is recorded as that of C, but from a certain point in time, there is a deterioration indication of abruptly increasing the deterioration point accumulated value, and thus a larger number of deterioration point is added. Thus, it is estimated that the estimate time Dt when the approximate straight line reaches the upper limit value is earlier than Ct. In the case of D, the apparatus control unit 34 issues a warning that there is an abrupt deterioration indication, and prompts to apply a normality confirmation test of the optical pluggable module 50. For example, the apparatus control unit 34 may issue a warning in the case where an increase degree (for example, a derivative value) of the deterioration point accumulated value is equal to or higher than a predetermined value.

In the case of E, the deterioration point is increased at an aging deterioration level for some time, but there is an abrupt deterioration indication from a certain point in time, and the deterioration point reaches an intermediate area. For E, the apparatus control unit 34 issues a preliminary warning indicating that the aging deterioration risk has increased, and may prompt application of the normality confirmation test of the optical pluggable module 50, and early replacement of the optical pluggable module 50.

In the case of F, the deterioration point is gradually increasing at aging deterioration level for a certain period of time. However, about the time of entering the intermediate area, the deterioration point increases abruptly to reach the upper limit value. In the case of F, the apparatus control unit 34 may issue a warning indicating that the failure occurrence risk has increased, and prompt early replacement of the optical pluggable module.

Next, a description will be given of use for cause investigation in the case where deterioration abruptly becomes worse, and the situation goes to a “sudden death” such as the occurrence of a failure. In the case where although the optical pluggable module 50 operates normally for a certain period of time, deterioration suddenly occurs in the optical pluggable module 50, causing a “sudden death”, it is thought that there are various causes of the failure. It is desirable to investigate a cause that leads to the sudden death, and to take measures to avoid the same failure. However, a failure due to a “sudden death” occurs abruptly. Thus, in order to perform the cause investigation, there are cases where it is difficult to collect cause investigation information in consideration of restarting the failed system, and the influence to the other systems in operation.

On the other hand, in the present embodiment, a relationship between the deterioration point accumulated value and the operating time is recorded as a table in the storage unit 35. Accordingly, it is possible to use the record of the indications from the operation initial state of the optical pluggable module 50 to the sudden death as cause investigation information. The data is stored as model cases of the occurrence of a sudden death, and is classified by deterioration patterns. Thus, it is possible to use the data for determination of the deterioration tendency and failure prediction of the other optical pluggable modules 50 that are operating on the same condition.

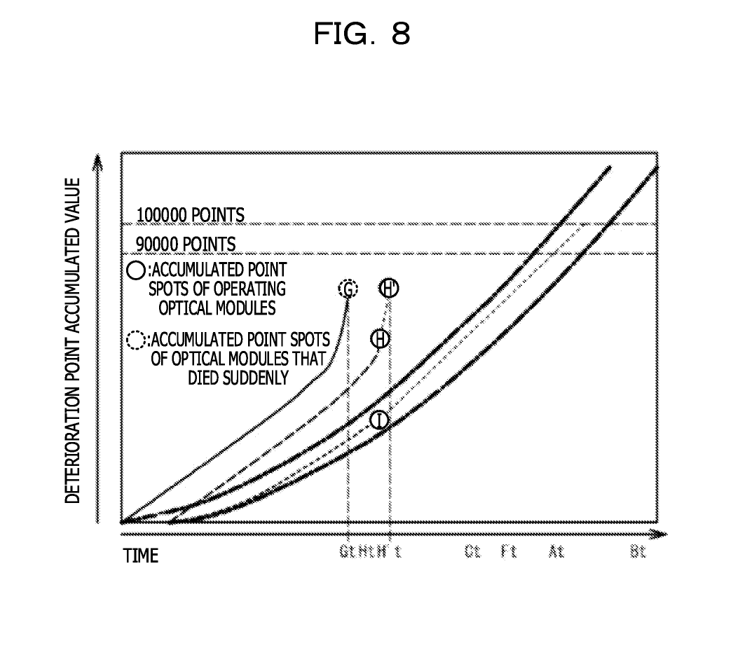

FIG. 8 is a diagram illustrating a relationship (monitoring example 2) between the operating time (the accumulated value), and the deterioration point accumulated value. Referring to FIG. 8, a line to a point G in time is a storage tendency of the deterioration point accumulated value of G, which has the occurrence of a sudden death failure. On the other hand, lines to points H and I, which started later than the operation start time of G, pertain to the same optical pluggable modules 50. However, because of the difference of the operational environments, the tendencies of the stored deterioration point accumulated values are different.

In the same optical pluggable module 50, more than in the case of gradually increasing the deterioration point accumulated value as I, in the case of H having a similar increase tendency of the deterioration point accumulated value, it is thought that there has been deterioration influence that results in the same sudden death. Accordingly, a determination is made that there is a possibility of the occurrence of a sudden death at a point in time when the deterioration point accumulated value becomes the same point as the point where G had a sudden death on an approximate straight line from the point H in time. In this manner, by classifying data of the deterioration point accumulated value into deterioration patterns, it is possible to use the data in order to investigate a cause of a sudden death, and to avoid a failure before the failure happens.

Next, a description will be given of a mechanism of monitoring deterioration of the optical pluggable module 50 continuously in the case where the optical pluggable module 50 is unplugged from a port, and then is mounted to any one of the ports. The optical pluggable module 50 has convenience in that only that part is allowed to be replaced. On the other hand, in order to continuously monitor aging deterioration states of individual modules that have been replaced or mounted again, it is preferable to store those data (the aging deterioration indication in the operation state, and the degree of accumulation of deterioration) individually in association with each other.

In order to record all of the numeric information for monitoring the aging deterioration indications of the plurality of optical pluggable modules 50 that are mounted to the transmission apparatus 100, an enormous memory capacity is desired. For example, it becomes possible to record all of the numeric information by storing the data into a unit that allows mounting an enormous memory capacity, or by transmitting the data to a server. However, the individual optical pluggable modules 50 have a limited memory capacity, and thus it is difficult to store all of the information into the optical pluggable module 50.

The above-described deterioration point accumulated value is information having only a few bytes, which includes the number of added points as a deterioration point. The operating time (the accumulated value) is also information having a few bytes. It becomes possible to store the numeric values into a user rewritable area of the optical pluggable module 50 by overwriting the numeric values at predetermined time intervals. Accordingly, in the case where the optical pluggable module 50 is mounted to another port, or to another transmission apparatus by temporary unplugging, and changing the configuration, or the like, it is possible to use the deterioration point accumulated value, and the operating time (the accumulated value). In this case, it becomes possible to continually accumulate the deterioration points, and to use the deterioration points for monitoring aging deterioration by referring to the operating time (the accumulated value), and the deterioration point accumulated value.

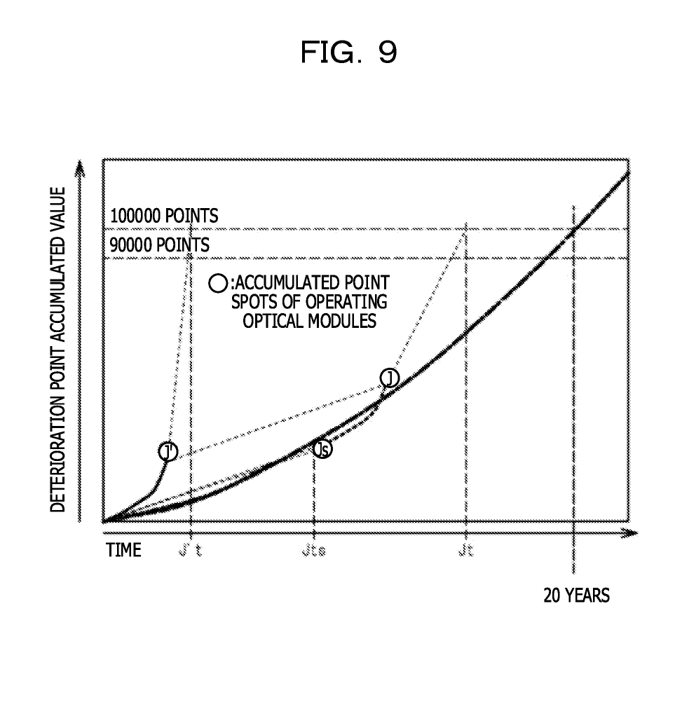

FIG. 9 is a diagram illustrating a relationship (monitoring example 3) between operating time (accumulated value), and deterioration point accumulated value. The example in FIG. 9 illustrates an example of accumulation of the deterioration point accumulated value in the case of reusing the optical pluggable module 50 that has been operated in another transmission apparatus. The line of J′ is a line produced when the deterioration point of the optical pluggable module 50 that was mounted again has been increased from 0. The accumulation tendency of J′ is observed so as to indicate an abrupt deterioration tendency, and it is predicted that the crossing J′t of an approximate straight line and an upper limit value is located at a considerably early time. However, it is possible for the apparatus control unit 34 to read the deterioration point accumulated value Js, and the record of the operating time Jts from the DDM unit 54 before operating the optical pluggable module 50 of J, and to start addition of the deterioration point accumulated value after that. Accordingly, the accumulation tendency of the deterioration point accumulated value becomes a tendency produced by adding the accumulation tendency before the restart, and thus it is possible to determine to be in the state that addition of the aging deterioration level has been carried out.

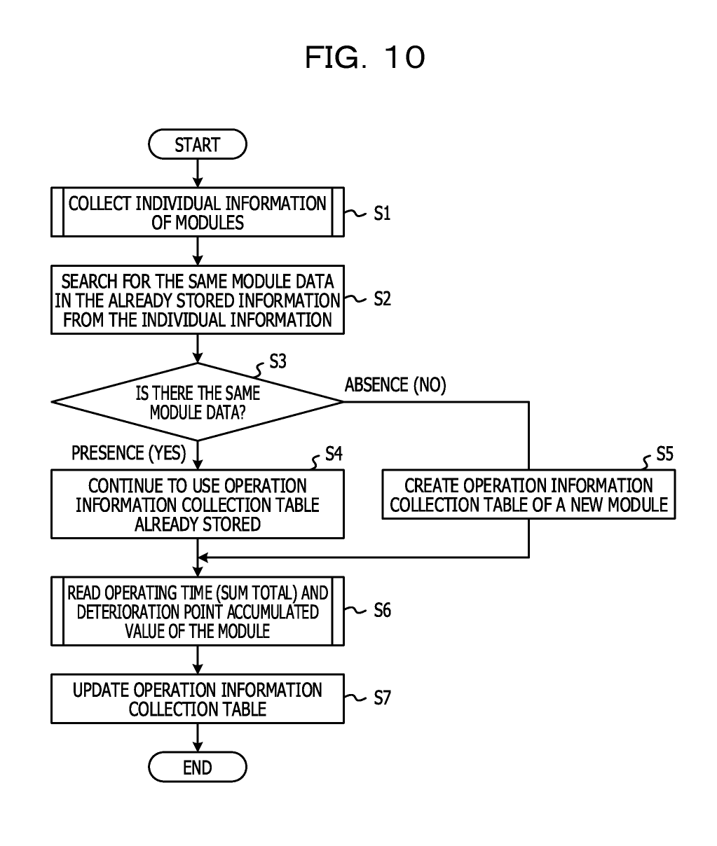

In the following, a description will be given of an example of a flowchart of the processing executed when the operation information collection table is updated at the time of mounting the optical pluggable module with reference to FIG. 10. When the optical pluggable module 50 is mounted or remounted, the apparatus control unit 34 collects individual information of the optical pluggable module 50 (S1). Next, the apparatus control unit 34 searches for the operation information collection table of the same optical pluggable module 50 in the storage information in the storage unit 35 (S2) from the individual information collected in S1. Next, the apparatus control unit 34 determines whether the operation information collection table of the same optical pluggable module 50 is existent in the storage unit 35 or not (S3).

If determined to be “Yes” in S3, the apparatus control unit 34 continues to use the operation information collection table stored already (S4). If determined to be “No” in S3, the apparatus control unit 34 newly creates an operation information collection table (S5). After execution of S4 or S5, the apparatus control unit 34 reads records of the operating time and the deterioration point, which is stored in the optical pluggable module 50 (S6). Next, the apparatus control unit 34 writes the operating time (the accumulated value), and the deterioration point accumulated value, which has been read, into the operation information collection table of the optical pluggable module 50 in the storage unit 35 (S7). Thereby, the information in the operation information collection table, and the information of the newly mounted optical pluggable module are synchronized, and the deterioration monitoring of the optical pluggable module is started.

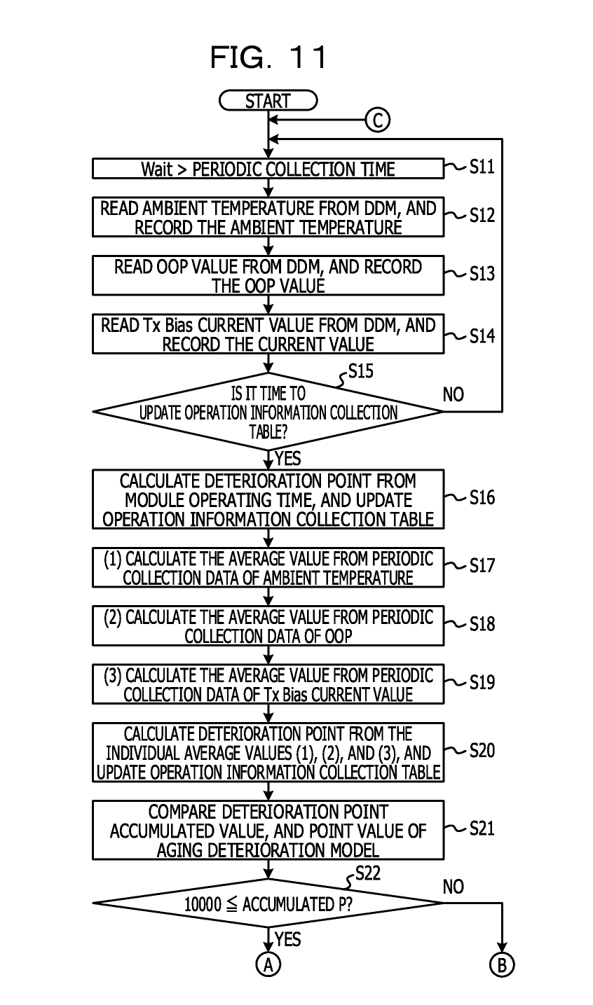

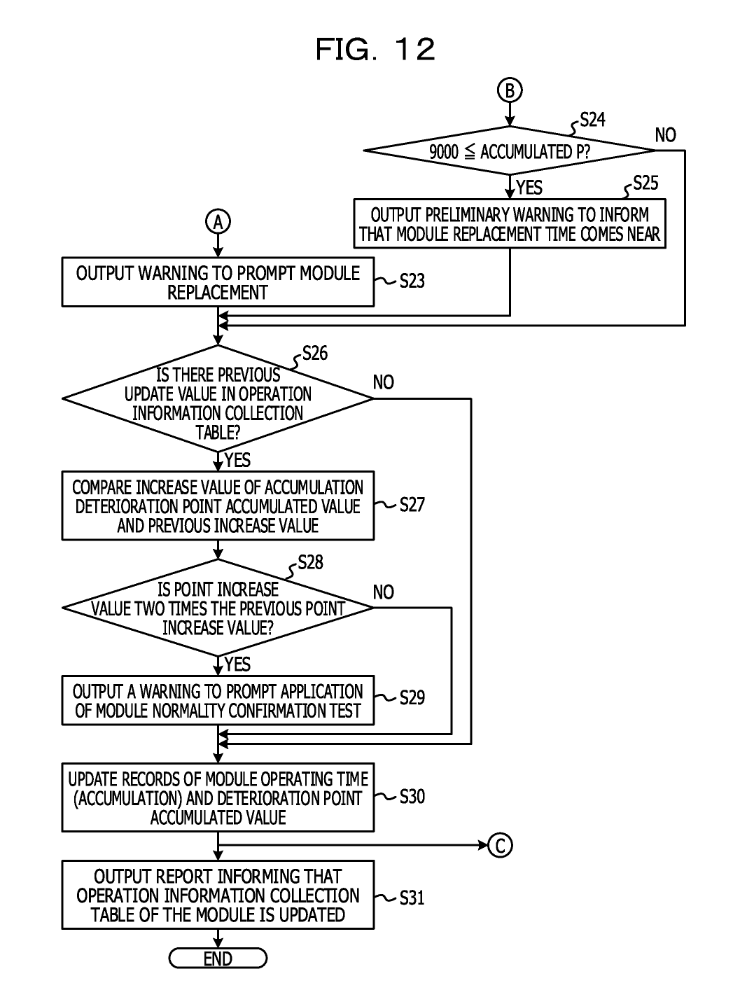

FIG. 11 and FIG. 12 are examples of a flowchart illustrating details of operation information collection and update of an operation information collection table from when deterioration monitoring of the optical pluggable module is started. Referring to FIG. 11 and FIG. 12, the apparatus control unit 34 waits for a periodic collection time (S11). Next, the apparatus control unit 34 reads a detection temperature by the temperature sensor 53 from the DDM unit 54, and records the detection temperature into the storage unit 35 (S12). Next, the apparatus control unit 34 reads an OOP value from the DDM unit 54, and records the OOP value into the storage unit 35 (S13). Next, the apparatus control unit 34 reads a bias value of the transmitter 52 from the DDM unit 54, and records the bias value into the storage unit 35 (S14).

Next, the apparatus control unit 34 determines whether it is time to update the operation information collection table or not (S15). For the update time, the update cycle of the operation information collection table is used. If determined to be “No” in S15, S11 is executed again. If determined to be “Yes” in S15, the apparatus control unit 34 calculates a deterioration point from the operating time, and records the deterioration point in the operation information collection table (S16). Next, the apparatus control unit 34 calculates the average value of the detection temperatures of the temperature sensor 53, which have been obtained at periodic collection time intervals (S17). Next, the apparatus control unit 34 calculates the average value of the OOP values obtained at the periodic collection time intervals (S18). Next, the apparatus control unit 34 calculates the average value of the bias values of the transmitter 52, which have been obtained at the periodic collection time intervals (S19). Next, the apparatus control unit 34 calculates a deterioration point from the average values calculated in S17 to S19, and records the deterioration point into the operation information collection table (S20).

Next, the apparatus control unit 34 compares the deterioration point accumulated value, and the number of points of the aging deterioration model (the upper limit value, the lower limit value of the intermediate area, and the like) (S21). Next, the apparatus control unit 34 determines whether the deterioration point accumulated value is equal to or more than a first threshold value (for example, 10000) (S22). If determined to be “Yes” in S11, the apparatus control unit 34 outputs a warning to prompt replacement of the optical pluggable module 50 (S23). If determined to be “No” in S21, the apparatus control unit 34 determines whether the deterioration point accumulated value is equal to or more than a second threshold value (for example, 9000) (S24). If determined to be “Yes” in S24, the apparatus control unit 34 outputs a preliminary warning to notify that the replacement time of the optical pluggable module 50 is approaching (S25).

After execution of S23 or S25, or if determined to be “No” in S24, the apparatus control unit 34 determines whether there is an updated value in the previous operation information collection table or not (S26). If determined to be “Yes” in S26, the apparatus control unit 34 compares the increase value of the deterioration point, and the previous increase value of the deterioration point (S27). Next, the apparatus control unit 34 determines whether the increase value of the deterioration point is equal to more than two times the previous increase value (S28). If determined to be “Yes” in S28, the apparatus control unit 34 outputs a warning to prompt application of the normality confirmation test of the pluggable module (S29). If determined to be “No” in S26, or after execution of S29, the apparatus control unit 34 updates the records of the operating time (the accumulated value), and the deterioration point accumulated value (S30) in the operation information collection table. At this time, the apparatus control unit 34 causes the DDM data collection/write unit 32 to write the operating time (the accumulated value), and the deterioration point accumulated value into the DDM unit 54. After that, the apparatus control unit 34 outputs a report to inform that the operation information collection table has updated (S31). The processing is executed again from S11.

By the present embodiment, the operating time (the accumulated value), and the deterioration point accumulated value are recorded in the DDM unit 54 of the optical pluggable module 50. With this configuration, even if the optical pluggable module 50 is unplugged from a port, and is remounted, it is possible to continue to monitor the deterioration tendency by reading the recorded operating time, and the deterioration point accumulated value. That is to say, in the case of replacing the optical pluggable module 50, even if the optical pluggable module 50 has been used in another port, it is possible to consider a change in the deterioration speed in accordance with that use. As a result, it is possible to predict a failure deterioration state with high precision. For example, by adding the deterioration additional point based on the operating time to the deterioration point accumulated value after remounting, it is possible to predict a failure deterioration state with high precision.

In the transmission apparatus 100, by recording a relationship between the operating time of the optical pluggable module 50, and the deterioration point accumulated value as a table, it becomes possible to compare with the accumulation tendency of the deterioration point of an aging deterioration model obtained in advance. It becomes possible to determine how the deterioration point accumulated value of the optical pluggable module 50 changes, and in what state the optical pluggable module 50 is in now, and thus to prompt a maintenance personnel to be aware of the importance of carrying out a normality test of the optical pluggable module 50, or early replacement.

Using a deterioration additional point that is weighted higher as the failure risk increases, it is possible to determine that the failure risk is increasing not only at the occurrence time of an abrupt deterioration phenomenon, but also at the time of a gradual deterioration phenomenon caused by natural aging deterioration. Accordingly, it is possible to indicate replacement time of the optical pluggable module 50 having an increased failure risk, execution time of a normality test, or the like to a maintenance personnel.

The deterioration point accumulated value is monitored all the time from an initial stage at which the optical pluggable module 50 normally operates. Accordingly, at the initial stage at which the optical pluggable module 50 normally operates, it is possible to calculate time at which a failure occurrence risk increases in the future. It is possible to use the deterioration point accumulated value for preparation of a replacement module, and test-time setting information as prior protection measures for the maintenance of the apparatus.

Further, a relationship between the operating time of the optical pluggable module 50, and the deterioration point accumulated value is recorded in the operation information collection table so that it is possible to use the accumulated information of deterioration point for cause investigation with respect to a sudden death. Referring to the deterioration patterns, it is possible to avoid the occurrence of a failure on the same condition before the failure actually occurs.

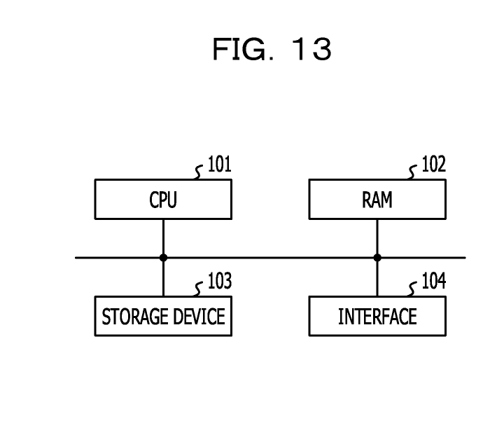

The operation monitoring unit 31, the DDM data collection/write unit 32, the operation information collection unit 33, and the apparatus control unit 34 in the above-described example may be configured by dedicated circuits, and the like, but may also achieved by a program. FIG. 13 is a block diagram for explaining a hardware configuration for achieving each unit by the program. Referring to FIG. 13, the hardware configuration may includes a central processing unit (CPU) 101, a RAM 102, a storage device 103, an interface 104, and the like. Each of these devices is connected through a bus, or the like.

The CPU 101 is a central arithmetic processing unit, and includes one or more cores. The random access memory (RAM) 102 is a volatile memory that stores a control program of a transmission apparatus executed by the CPU 101, and temporarily stores data processed by the CPU 101, and the like. The storage device 103 is a nonvolatile storage device, and stores the control program of the transmission apparatus according to each of the embodiments. It is possible to use a solid state drive (SSD), such as a read only memory (ROM), a flash memory, or the like, a hard disk that is driven by a hard disk drive, or the like for the storage device 103, for example. The interface 104 is a device that transmits and receives a signal with an external device. The CPU 101 may execute the control program of the transmission apparatus so as to achieve the operation monitoring unit 31, the DDM data collection/write unit 32, the operation information collection unit 33, and the apparatus control unit 34.

In the above-described example, the optical pluggable module 50 corresponds to an optical module including a memory. The apparatus control unit 34, and the storage unit 35 correspond to a recording unit that records the operating time of the optical module, and the deterioration point accumulated value at predetermined intervals at the time of mounting the optical module. The apparatus control unit 34 corresponds to the prediction unit that predicts a deterioration degree of the optical module based on the operating time, and the deterioration point accumulated value recorded in the memory after the optical module is remounted to any one of the ports. The apparatus control unit 34 corresponds to the output unit that outputs a warning when the deterioration point accumulated value has reached the first threshold value, and outputs a preliminary warning when the deterioration point accumulated value has reached the second threshold value that is lower than the first threshold value.

In the above, a detailed description has been given of an embodiment of the present disclosure. The present disclosure is not limited to a specific embodiment, and various variations and changes may be made within the scope of the appended claims of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of controlling a transmission apparatus, executed by a processor, the transmission apparatus including a plurality of ports capable of connection to an optical module, the method comprising:
receiving operating time information indicating information of operating time of the optical module, and monitor information including at least one of information on temperature of the optical module, optical output power of the optical module, and a bias current value of a semiconductor laser disposed in the optical module at predetermined time intervals, when the optical module is coupled to a first port among the plurality of ports;
calculating a deterioration point indicating a deterioration degree of the optical module based on the operating time information and the monitor information at the predetermined time intervals;
calculating an accumulated deterioration point by adding the deterioration point calculated at the predetermined time intervals; and
determining a deterioration degree of the optical module based on the accumulated deterioration point, when the optical module is recoupled to the first port, or when the optical module is coupled to a second port different from the first port among the plurality of ports.

2. The method according to claim 1,
wherein the calculating of the deterioration point includes calculating the deterioration point using a value weighted in accordance with a failure risk of the optical module.

3. The method according to claim 2,
wherein the calculating of the deterioration point includes calculating the deterioration point using a value weighted in accordance with a failure risk increasing as the operating time becomes longer.

4. The method according to claim 3,
wherein the calculating of the deterioration point includes calculating a value obtained by dividing a number of operating days of the optical module by a predetermined number as the deterioration point.

5. The method according to claim 1, further comprising:
storing the operating time information of the optical module, and the accumulated deterioration point in association with each other into a memory.

6. The method according to claim 5,
wherein the determining includes predicting failure time of the optical module by comparing a tendency of a relationship between the accumulated deterioration point and the operating time with a tendency of a relationship between the accumulated deterioration point and the operating time of an optical module other than the optical module stored in the memory.

7. The method according to claim 1, further comprising:
outputting a warning when the accumulated deterioration point reaches a first threshold value, and when the accumulated deterioration point reaches a second threshold value lower than the first threshold value.

8. A transmission apparatus including a plurality of ports capable of connection to an optical module, the transmission apparatus comprising:
a memory; and
a processor coupled to the memory and configured to:
receive operating time information indicating information of operating time of the optical module, and monitor information including at least one of information on temperature of the optical module, optical output power of the optical module, and a bias current value of a semiconductor laser disposed in the optical module at predetermined time intervals, when the optical module is connected to any first port of the plurality of ports,
calculate a deterioration point indicating a deterioration degree of the optical module based on the operating time information and the monitor information at the predetermined time intervals,
calculate an accumulated deterioration point by adding the deterioration point calculated at the predetermined time intervals, and
determine a deterioration degree of the optical module based on the accumulated deterioration point, when the optical module is recoupled to the first port, or when the optical module is coupled to a second port different from the first port among the plurality of ports.

9. The transmission apparatus according to claim 8,
wherein the processor is configured to calculate the deterioration point using a value weighted in accordance with a failure risk of the optical module.

10. The transmission apparatus according to claim 9,
wherein the processor is configured to calculate the deterioration point using a value weighted in accordance with a failure risk increasing as the operating time becomes longer.

11. The transmission apparatus according to claim 10,
wherein the processor is configured to calculate a value obtained by dividing a number of operating days of the optical module by a predetermined number as the deterioration point.

12. The transmission apparatus according to claim 8,
wherein the processor is configured to store the operating time information of the optical module, and the accumulated deterioration point in association with each other into a memory.

13. The transmission apparatus according to claim 12,
wherein the processor is configured to predict failure time of the optical module by comparing a tendency of a relationship between the accumulated deterioration point and the operating time with a tendency of a relationship between the accumulated deterioration point and the operating time of an optical module other than the optical module stored in the memory.

14. The transmission apparatus according to claim 8,
wherein the processor is configured to output a warning when the accumulated deterioration point reaches a first threshold value, and when the accumulated deterioration point reaches a second threshold value lower than the first threshold value.

15. A computer-readable recording medium storing a program causing a computer to execute a process, the process comprising:
receiving operating time indicating information of operating time of the optical module, and monitor information including at least one of information on temperature of the optical module, optical output power of the optical module, and a bias current value of a semiconductor laser disposed in the optical module at the predetermined time intervals, when a module is coupled to any first port of a plurality of ports disposed on a transmission apparatus;
calculating a deterioration point indicating a deterioration degree of the optical module based on the operating time information and the monitor information at the predetermined time intervals;
calculating an accumulated deterioration point by adding the deterioration point calculated at the predetermined time intervals; and
determining a deterioration degree of the optical module based on the accumulated deterioration point, when the optical module is reconnected to the first port, or when the optical module is connected to a second port different from the first port among the plurality of ports.
